(19) United States
(12) Patent Application Publication
(10) Pub. No.: US 2011/0266332 A1
(43) Pub. Date: Nov. 3, 2011

(54) METHOD FOR MANUFACTURING A BICYCLE RIM

(76) Inventor: Chun Hsun Lo, TAICHUNG CITY (TW)

(21) Appl. No.: 13/180,545

(22) Filed: Jul. 12, 2011

Related U.S. Application Data
(63) Continuation-in-part of application No. 12/657,058, filed on Jan. 13, 2010.

(51) Int. Cl. B23K 31/02

(52) U.S. Cl. 228/162

(57) ABSTRACT

A method for manufacturing a bicycle rim includes the following steps. A first bar of material and a second bar of material are formed by extrusion. The first bar and the second bar are respectively made into an arched section of material (unfinished external ring, unfinished internal ring) and cut. Excessive portions of the unfinished external and internal rings are cut from by trimming. The unfinished external and internal rings are assembled and interconnected to each other. The assembled unfinished external and internal rings are laterally pressed to promote a connection between the unfinished external and internal rings. The ends of the unfinished external ring are welded and connected to each other, and the ends of the unfinished internal ring are welded and connected to each other to from a rim structure. Any roughness of the rim structure is ground and the bicycle rim is finished.

### CROSS-REFERENCE TO RELATED APPLICATION

This application is a Continuation-In-Part application of Ser. No. 12/657,058, filed 13 Jan. 2010, and entitled “BICYCLE RIM”, now pending, the contents of which are included herein by reference.

### BACKGROUND OF THE INVENTION

1. Field of the Invention

The present invention relates to a bicycle field, and more particularly to a method for manufacturing a bicycle rim.

2. Description of Related Art

For the sake of environment protection and sport, bicycles have become popular vehicles particularly for short-distance travelers in urban areas. Functionality and styling are important factors taken into consideration by riders looking for bicycles. Collapsible bicycles are examples of such consideration. In addition to functionality and styling, strength and safety are also important factors taken into consideration by riders. This is the primary incentive for using aluminum alloy and carbon fiber rims in bicycles.

A method for making a carbon rim includes the steps of forming an inflated semi-product in a mold, inserting an air bag in the semi-product, inflating the air bag, heating the mold, taking the semi-product and the air bag from the mold, baking, and grinding. A carbon rim is of course light in weight, however, it is difficult to control the air pressure in the air bag and the heating of the mold. Hence, it takes about 90 minutes to finish a carbon rim, and the cost of a carbon is high.

With reference to FIGS. 10 and 11, there is shown a conventional rim made of aluminum alloy. A method for making such a conventional aluminum alloy rim includes the steps of extrusion, rolling, cutting, trimming, welding, and grinding in sequence. The conventional aluminum alloy rim includes two walls 51 and 52 integrally interconnected by an intermediate portion 53. A bead-receiving groove 54 is defined by the walls 54 and 52 and the intermediate portion 53. It is desired to make the rim with large depth in a radial direction. However, such an attempt entails risks of making wrinkles 55 on the walls 51 and 52 since they cannot be supported from the inside to keep them flat during rolling. Therefore, the depth of a conventional aluminum alloy rim cannot exceed 32 millimeters.

The present invention is therefore intended to obviate or at least alleviate the problems encountered in prior art.

### SUMMARY OF THE INVENTION

The main objective of the present invention is to provide an improved method for manufacturing a bicycle rim that has a smooth outer periphery.

To achieve the objective, the method in accordance with the present invention comprises the following steps.

A first bar of material and a second bar of material are formed by extrusion.

Rolling and cutting: a section of the first bar of material is made into an arched section of material (unfinished external ring) and cut from the first bar of material. A section of the second bar of material is made into an arched section of material (unfinished internal ring) and cut from the first bar of material. The unfinished external and internal rings respectively have a C-shaped structure. A roller extends into the unfinished internal ring and tightly abuts against an inner periphery of the unfinished internal ring to prevent the unfinished internal ring from being shrunk during rolling.

Trimming: excessive portions of the unfinished external and internal rings are cut from by trimming.

Assembling: the unfinished external and internal rings are assembled and interconnected to each other.

Pressing: the assembled unfinished external and internal rings are laterally pressed to promote a connection between the unfinished external and internal rings.

Welding: the ends of the unfinished external ring are welded and connected to each other, and the ends of the unfinished internal ring are welded and connected to each other to from a rim structure. and

Grinding: any roughness of the rim structure is ground and the bicycle rim is finished.

The rim made of the method in accordance with the present invention exhibits several advantages over the prior art. Firstly, the strength is enhanced because of the deep U-shaped configuration of the internal ring in the cross-sectional view without risks of causing wrinkles in the internal ring. The advantage results from the feature that the internal ring and the external ring are made separately and then assembled and a roller extends into the unfinished internal ring and tightly abuts against an inner periphery of the unfinished internal ring during rolling.

Further benefits and advantages of the present invention will become apparent after a careful reading of the detailed description with appropriate reference to the accompanying drawings.

### BRIEF DESCRIPTION OF THE DRAWINGS

FIG. 1 is a flow chart of a method for manufacturing a bicycle rim in accordance with the present invention;

FIG. 2 is a cross-sectional view of a bicycle rim that is made by the method as shown in FIG. 1;

FIG. 3 is an exploded perspective view of the bicycle rim that is made by the method as shown in FIG. 1;

FIG. 4 is a cross-sectional view of the internal ring during rolling;

FIG. 5 is a cross-sectional view of the bicycle rim after being assembly;

FIG. 6 is a perspective view of the bicycle rim after being pressed;

FIG. 7 is a cross-sectional view of the bicycle rim after being pressed;

FIG. 8 is a perspective view of the bicycle rim after being welded and ground;

FIG. 9 is a flow chart of another method for manufacturing a bicycle rim in accordance with the present invention;

FIG. 10 is a cross-sectional view of a conventional bicycle rim; and

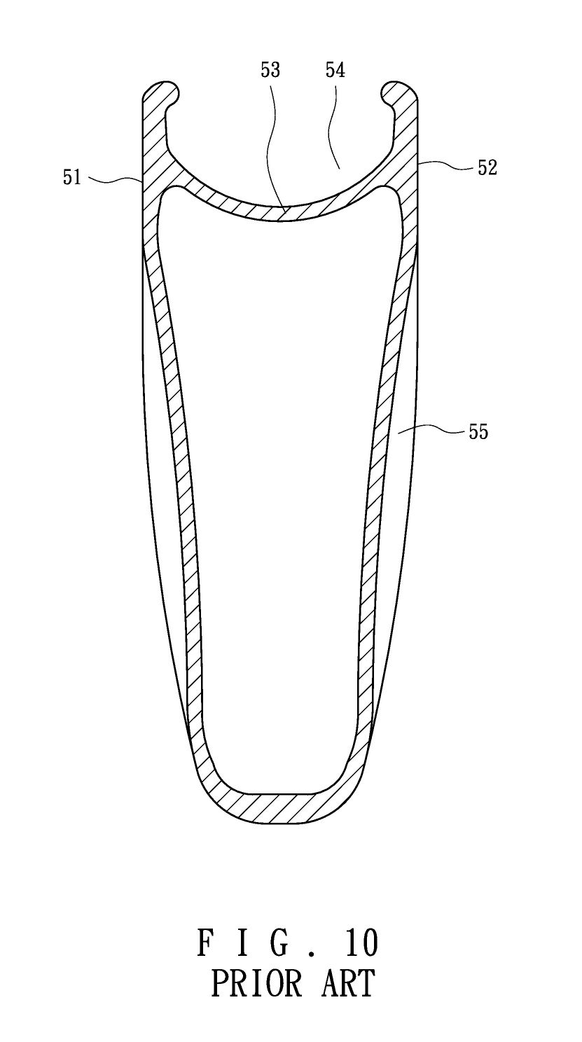

FIG. 11 is a partially perspective view of the conventional bicycle rim as shown in FIG. 10.

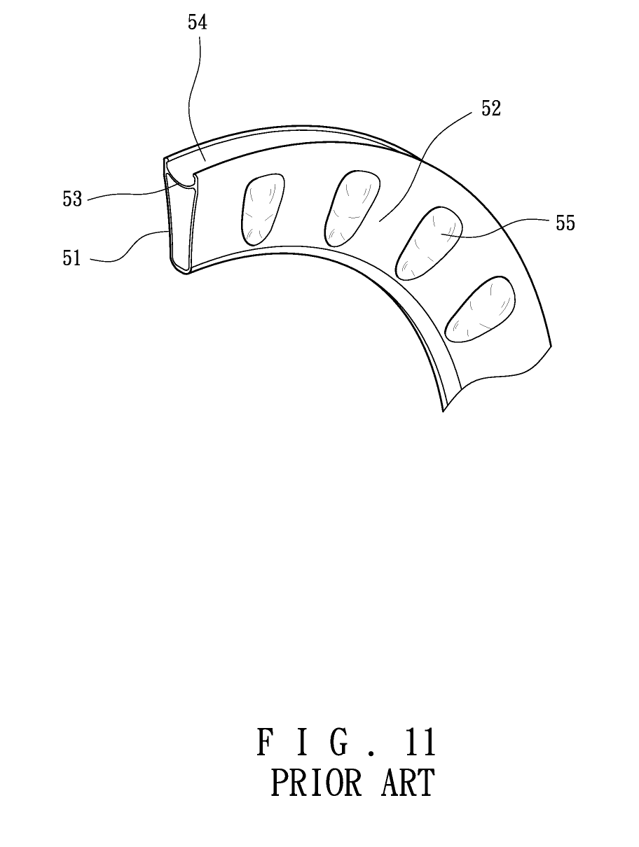

### DETAILED DESCRIPTION OF THE INVENTION

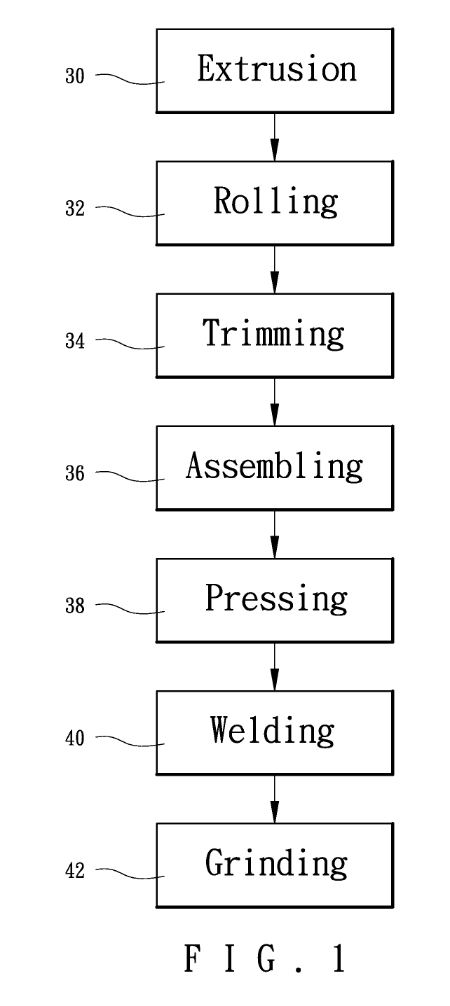

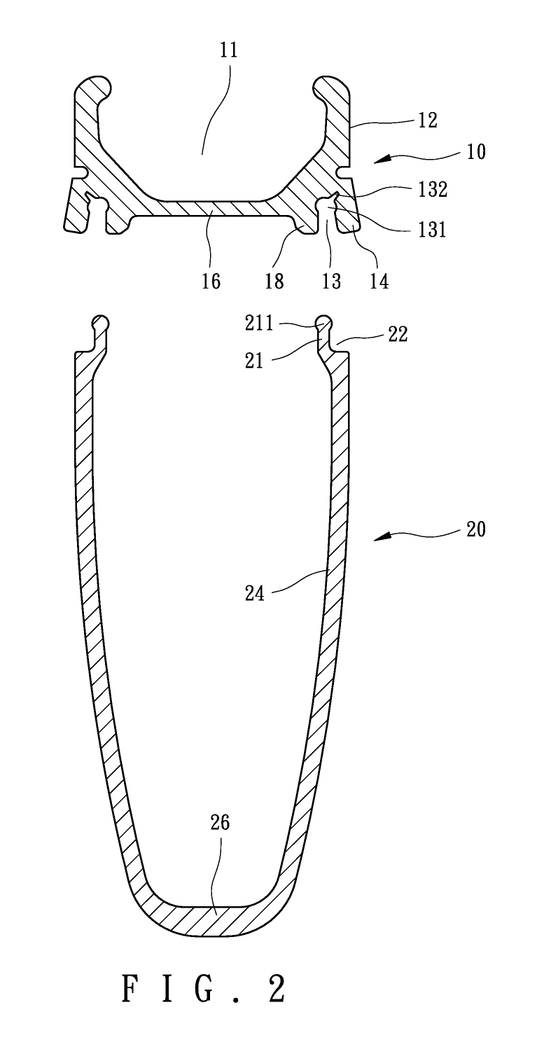

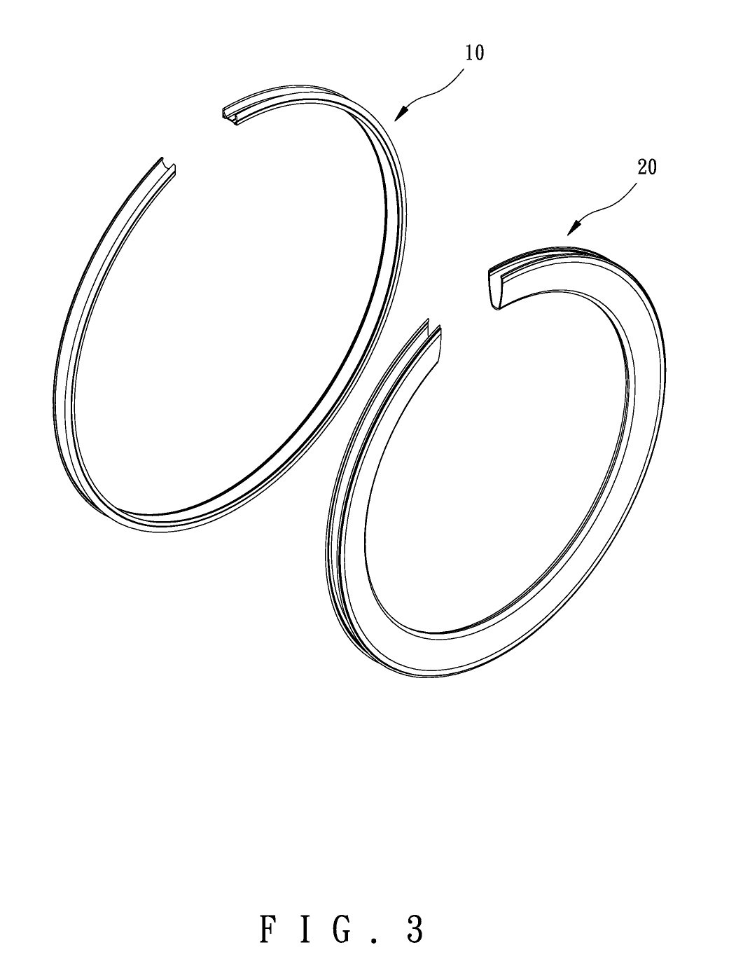

Referring to FIG. 1, there is shown a method for manufacturing a rim (FIGS. 2 and 3) according to the present invention as shown. The rim includes an internal ring 10 and an external ring 20 that are made separately and later assembled. At 30, by extrusion of stainless, magnesium or aluminum alloy, a first bar of material is made, and so is a second bar of material.

At 32, by rolling and cutting, a section of the first bar of material is made into an arched section of material (unfinished external ring) and cut from the first bar of material. Similarly, a section of the second bar of material is made into an arched section of material (unfinished internal ring) and cut from the first bar of material. Both of the unfinished external and internal rings look like a “C” along an axis about which the external ring 10 and the internal ring 20 are supposed to spin.

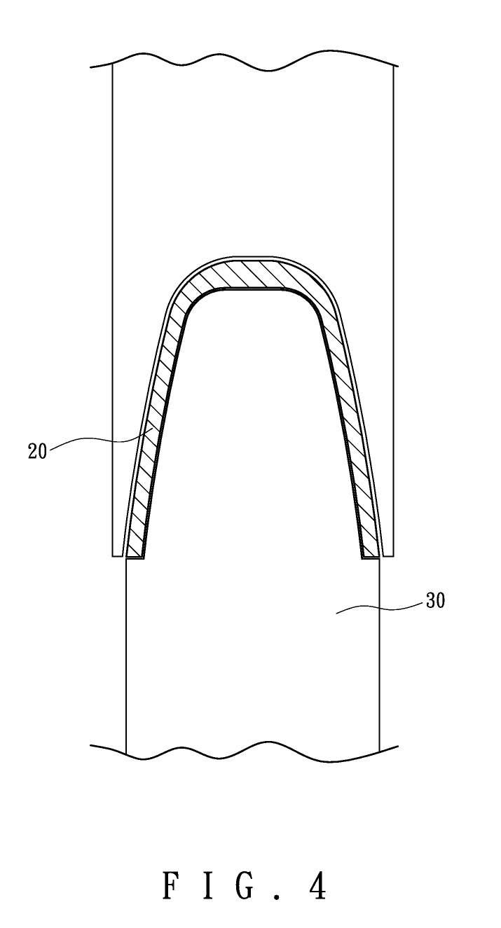

The lengths of the unfinished external and internal rings are larger than desired perimeters of the external 10 and the internal ring 20 because the cohesion of the molecules of the material and stress exerted on the material tend to make the material shrink after the rolling and cutting. As shown in FIG. 4, the unfinished internal ring has a U-shaped cross-section such that a roller 30 extends into the unfinished internal ring and tightly abuts against an inner periphery of the unfinished internal ring to prevent the unfinished internal ring from being shrunk during rolling. At 34, by trimming, excessive portions are cut from the unfinished external and internal rings. Therefore, the lengths of the unfinished external and internal rings are made equal to the desired perimeters of the external ring 10 and the internal ring 20. Moreover, the ends of the unfinished external and internal rings are made neat.

The external ring 10 includes two walls 12 and a middle portion 16 that interconnects the walls 12. The walls 12 extend from a first, external side of the middle portion 16. Each of the walls 12 includes an external, brake-contacting face. The brake-contacting face is generally in a plane in perpendicular to the axis. A bead-receiving groove 11 is defined by the walls 12 and the intermediate portion 16.

Two external flanges 14 extend from a second, internal side of the middle portion 16. Spacing of the internal side of the middle portion 16 from the axis is smaller than spacing of the external side of the middle portion 16. Spacing between the external flanges 14 increases as the external flanges 14 extend from the internal side of the middle portion 16.

Two internal flanges 18 also extend from the internal side of the middle portion 16. The internal flanges 18 are located between the external flanges 14 in an axial direction of the rim.

An edge-receiving groove 13 is defined between each of the external flanges 14 and a related one of the internal flanges 18. Hence, there are two edge-receiving groove 13 each including an open end and a closed. Because of the opening external flanges 14, a width of the edge-receiving groove 13 increases from the closed end to the open end. Each of the edge-receiving grooves 13 includes an enlarged portion 131. The width of the edge-receiving grooves 13 decreases from the open end to the closed end except within the enlarged portions 131.

A slit 132 is defined in the closed end of each of the edge-receiving grooves 13. Each of the slits 132 extends toward the brake-contacting face of the related wall 12 of the external ring 10 from the closed end of the related edge-receiving groove 13.

The internal ring 20 includes two walls 24 and an intermediate portion 26 that interconnects the walls 24. The walls 24 are made with an adequate dimension in the radial direction of the rim for the purposes of strength and security. When rolling the internal ring 20, the roller 30 extends into the unfinished internal ring and tightly abuts against an inner periphery of the unfinished internal ring such that the unfinished internal ring would not be shrunk during rolling and the finished internal ring 20 has a smooth periphery.

Each of the walls 24 includes an edge 21 and a shoulder 22. Spacing between the edges 21 is smaller than spacing between major portions of the walls 24 so that the shoulders 22 are formed between the edges 21 and the major portions of the walls 24. Each of the edges 21 includes an enlarged portion 211. The enlarged portion 211 looks like a ball as shown in FIG. 2.

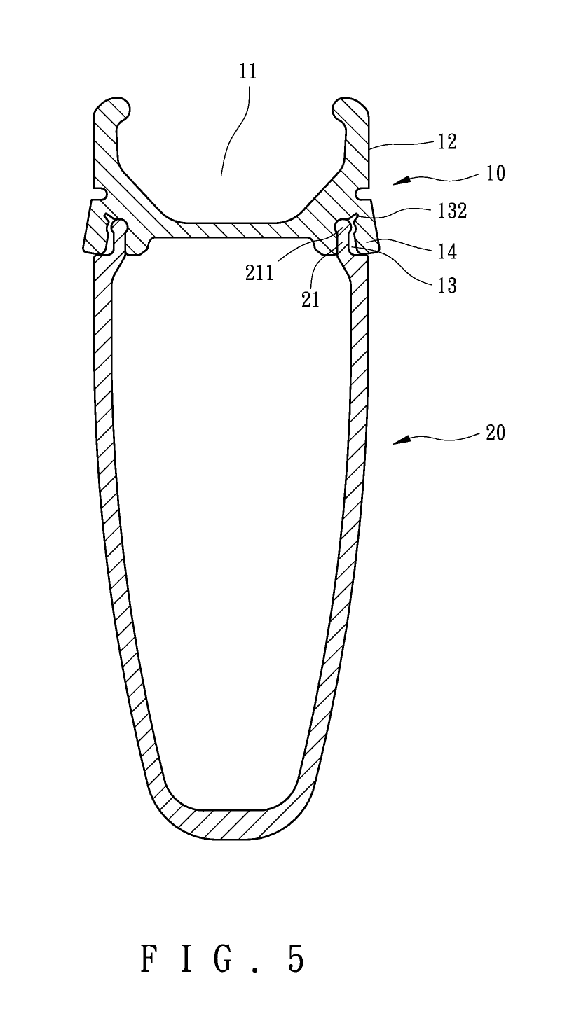

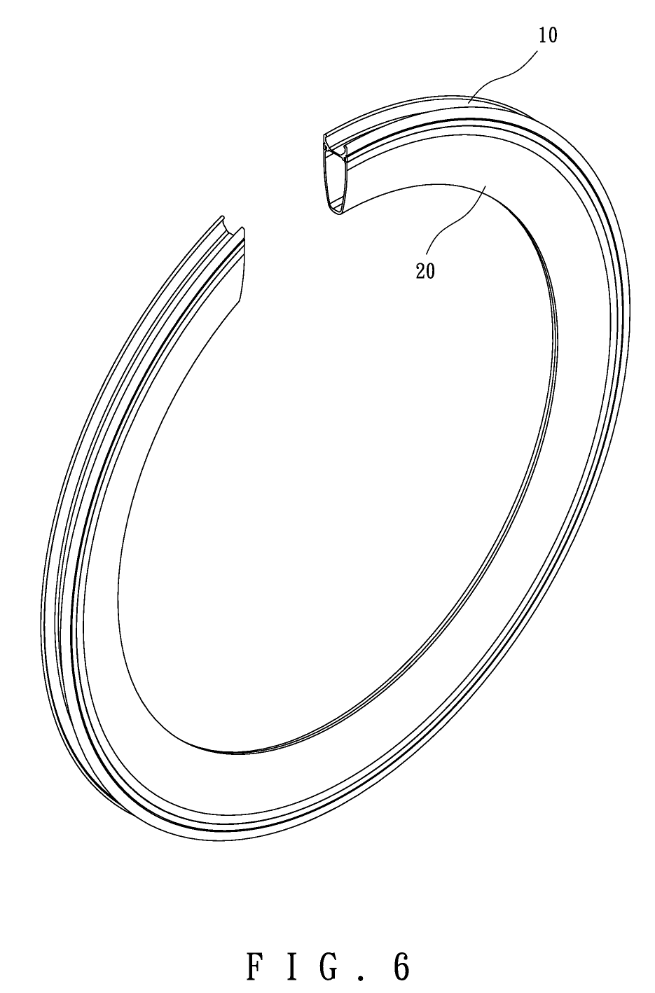

At 36, the unfinished external and internal rings are assembled as shown in FIGS. 5 and 6. In detail, the edges 21 are inserted in the edge-receiving grooves 13, thus interconnecting the unfinished internal and external rings. The enlarged portions 211 of the edges 21 are fit in the enlarged portions 131 of the edge-receiving grooves 13, thus enhancing the interconnection of the unfinished internal and external rings. The increasing width of the edge-receiving grooves 13 facilitates the insertion of the enlarged portions 211 of the edges 21 into the edge-receiving grooves 13. The shoulders 22 abut the external flanges 14 to enhance the strength of the rim in the radial direction.

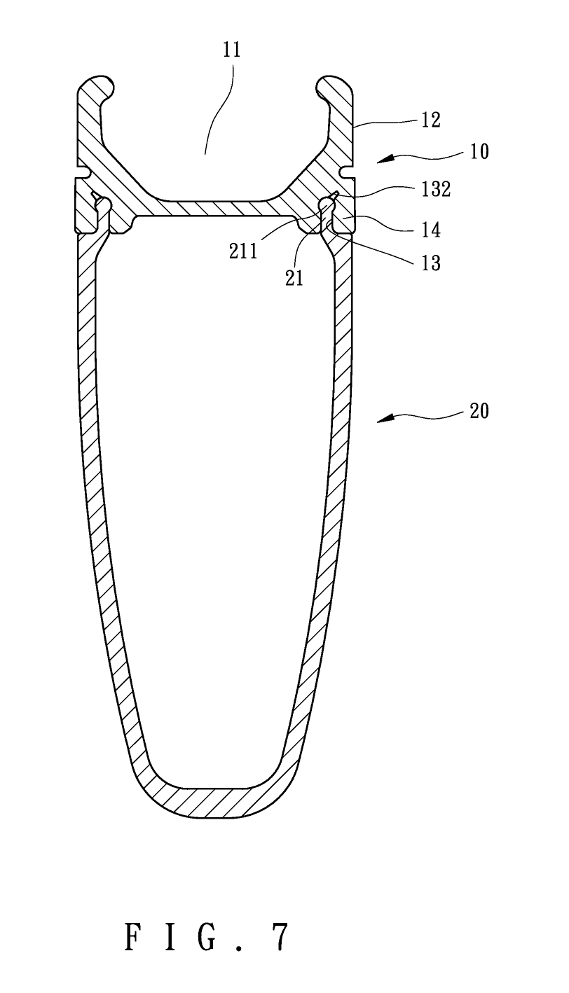

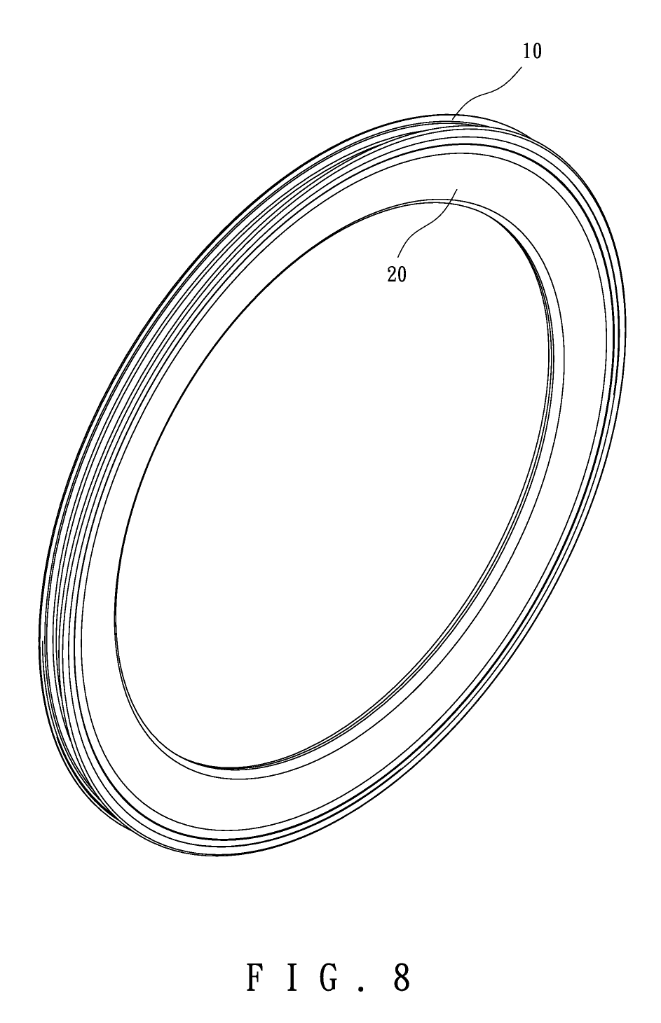

At 38, by pressing, the external flanges 14 are closed as shown in FIGS. 7 and 8. Thus, each of the edges 21 is firmly sandwiched between a related one of the external flanges 14 and a related one of the internal flanges 18. Moreover, the enlarged portions 211 of the edges 21 are retained in the enlarged portions 131 of the edge-receiving grooves 13. The slits 132 reduce stress within the external flanges 14 of the external ring 10. For aesthetical purposes, the external flanges 14 are in flush with the walls 24.

At 40, by welding, the ends of the unfinished external ring are connected to each other, and so are the ends of the unfinished internal ring to from a rim structure. The welding method can be argon-based welding or spot welding.

At 42, grinding and the rim is finished. By the grinding, any roughness of the rim, particularly in the areas of welding, is removed.

Spokes can be provided between a hub and the rim. A tube and a tire can be provided on the rim. Two beads of the tube can be inserted in the bead-receiving groove 11.

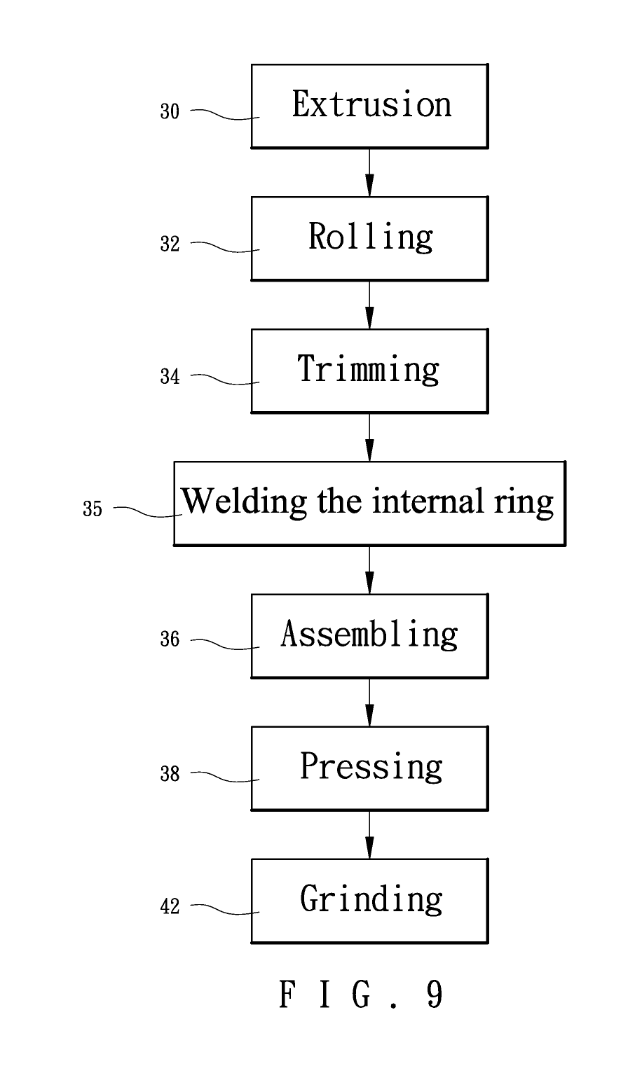

Referring to FIG. 9, there is shown another method for manufacturing the rim in accordance with the present invention. This method is like the foregoing method except including a step of welding 35 the internal ring 20 before mounting the external ring 10 on the internal ring 20. Omitted is the welding 40 of the external ring 10 in the foregoing. Therefore, this method includes extrusion 30, rolling and cutting 32, trimming 34, welding 35 the internal ring 20, assembling 36, pressing 38 and grinding 42 in sequence.

The rim made of the method in accordance with the present invention exhibits several advantages over the prior art. Firstly, the strength is enhanced because of the deep U-shaped configuration of the internal ring 20 in the cross-sectional view without risks of causing wrinkles in the internal ring 20. The advantage results from the feature that the internal ring 20 and the external ring 10 are made separately and then assembled and a roller extends into the unfinished internal ring and tightly abuts against an inner periphery of the unfinished internal ring during rolling.

Secondly, time and related cost for manufacturing the rim are reduced.

Thirdly, it provides customers with various combinations of external ring with internal ring to best satisfy their needs because the external ring 10 and the internal ring 20 are made separately. Hence, they can be made of different materials. That is, a composite rim is possible.

Although the invention has been explained in relation to its preferred embodiment, it is to be understood that many other possible modifications and variations can be made without departing from the spirit and scope of the invention as hereinafter claimed.

What is claimed is:

1. A method for manufacturing a bicycle rim comprising the steps of:
forming a first bar of material and a second bar of material by extrusion;
rolling and cutting: a section of the first bar of material made into an arched section of material (unfinished external ring) and cut from the first bar of material, a section of the second bar of material made into an arched section of material (unfinished internal ring) and cut from the first bar of material, the unfinished external and internal rings having a C-shaped structure, a roller extending into the unfinished internal ring and tightly abutting against an inner periphery of the unfinished internal ring to prevent the unfinished internal ring from being shrunk during rolling;
trimming: excessive portions of the unfinished external and internal rings being cut from by trimming;
assembling: the unfinished external and internal rings being assembled and interconnected to each other;
pressing: pressing the assembled unfinished external and internal rings to promote a connection between the unfinished external and internal rings;
welding: the ends of the unfinished external ring being welded and connected to each other, and the ends of the unfinished internal ring being welded and connected to each other to from a rim structure; and
grinding: grinding and removing any roughness of the rim structure and the bicycle rim being finished.

2. The method as claimed in claim 1, wherein the welding method is argon-based welding.

3. The method as claimed in claim 1, wherein the welding method is spot welding.
